(19) United States
(12) Patent Application Publication
(10) Pub. No.: US 2014/0048347 A1
(43) Pub. Date: Feb. 20, 2014

(54) DUCTED WINDSHIELD FOR A MOTORCYCLE

(71) Applicants: Brian J. Munzel, Oconomowoc, WI (US); Robert J. Brummond, Waukesha, WI (US); Abid Husein Jeevraj, Pewaukee, WI (US); Joseph A. Nutt, Pewaukee, WI (US); Joseph E. Capodarco, Kenosha, WI (US); Matthew Anchor, Elm Grove, WI (US)

(72) Inventors: Brian J. Munzel, Oconomowoc, WI (US); Robert J. Brummond, Waukesha, WI (US); Abid Husein Jeevraj, Pewaukee, WI (US); Joseph A. Nutt, Pewaukee, WI (US); Joseph E. Capodarco, Kenosha, WI (US); Matthew Anchor, Elm Grove, WI (US)

(73) Assignee: HARLEY-DAVIDSON MOTOR COMPANY GROUP, LLC, Milwaukee, WI (US)

(21) Appl. No.: 13/589,808

(22) Filed: Aug. 20, 2012

(51) Int. Cl. B62J 17/04; B60J 1/20

(52) U.S. Cl. 180/219; 296/78.1

(57) ABSTRACT

A motorcycle windshield assembly includes a windshield having a forward surface and an opposed rearward surface. An aperture is provided through the windshield. A duct positioned in the aperture. The duct has a forward facing inlet and a rearward facing outlet positioned above the inlet. The duct has a length of at least 3.0 inches measured along a centerline between the inlet and the outlet. The outlet extends rearward of the rearward windshield surface and is oriented at an angle that is at least about 21 degrees and not more than about 35 degrees with the windshield.

### BACKGROUND

The present invention relates to windshields for motorcycles. More particularly, the invention relates to a ducted windshield assembly.

### SUMMARY

In one aspect, the invention provides a motorcycle windshield assembly including a windshield having a forward surface and an opposed rearward surface. An aperture is provided through the windshield. An air nozzle is formed by a duct positioned in the aperture. The duct has a forward facing inlet and a rearward facing outlet positioned above the inlet. The duct has a length measured along a centerline from the inlet to the outlet of at least 3.0 inches. The outlet extends rearward of the rearward windshield surface and is oriented at an angle that is at least about 21 degrees and not more than about 35 degrees with the windshield.

In another aspect, the invention provides a motorcycle including a rear wheel drivable to propel the motorcycle, a front wheel operable to steer the motorcycle, a seat having a surface configured to support a rider in an upright seated position, and a windshield assembly positioned forward of the seat to jointly define a cockpit area above the seat and rearward of the windshield assembly. The windshield assembly includes a windshield having a forward surface, an opposed rearward surface, and a top edge, the top edge being no more than 25 inches above the seat surface. A duct is positioned in an aperture through the windshield, the duct having a forward facing inlet and a rearward facing outlet positioned above the inlet. The outlet is directly exposed to the cockpit area to direct a steady stream of high velocity air to an upper portion of the cockpit area. The duct is centrally located along a width of the windshield and occupies more than one-third of the width.

Other aspects of the invention will become apparent by consideration of the detailed description and accompanying drawings.

### BRIEF DESCRIPTION OF THE DRAWINGS

FIG. 1 is a side view of a motorcycle including a windshield assembly according to at least one aspect of the invention.

FIG. 2 is a perspective view of the windshield assembly of FIG. 1.

FIG. 3 is an exploded assembly view of the windshield assembly of FIGS. 1-2.

FIG. 4 is a front view of the windshield assembly of FIGS. 1-3.

FIG. 5 is a cross-sectional view of the windshield assembly, taken along line 5-5 of FIG. 4.

FIG. 6 is a view of a duct outlet of the windshield assembly, with a movable vane in a closed position.

FIG. 7 is a view of the duct outlet of the windshield assembly, with the movable vane in an open position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

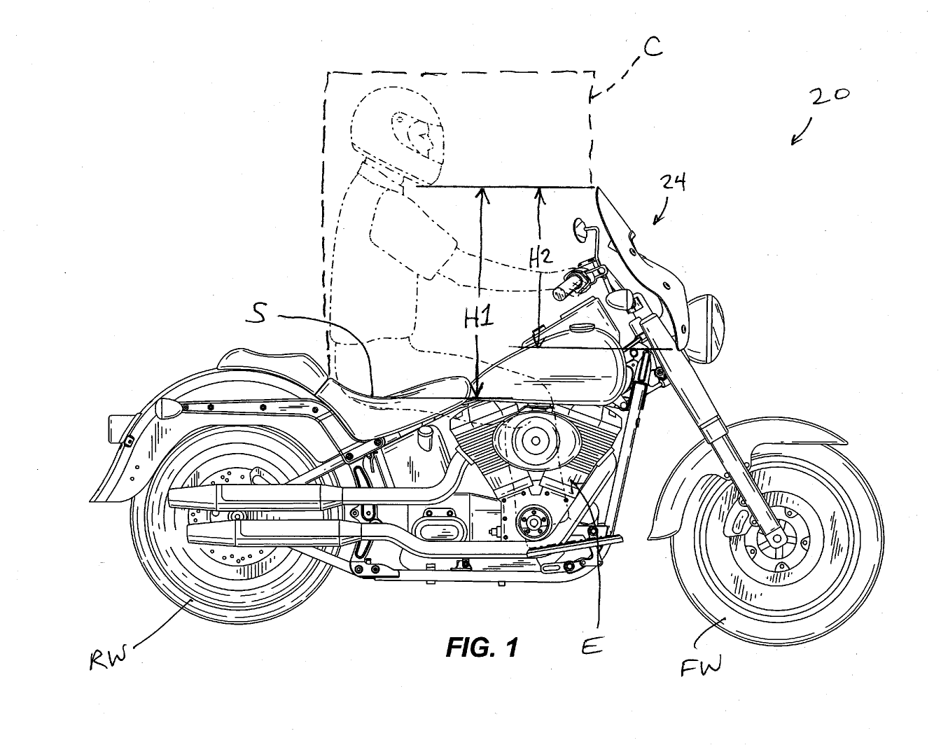

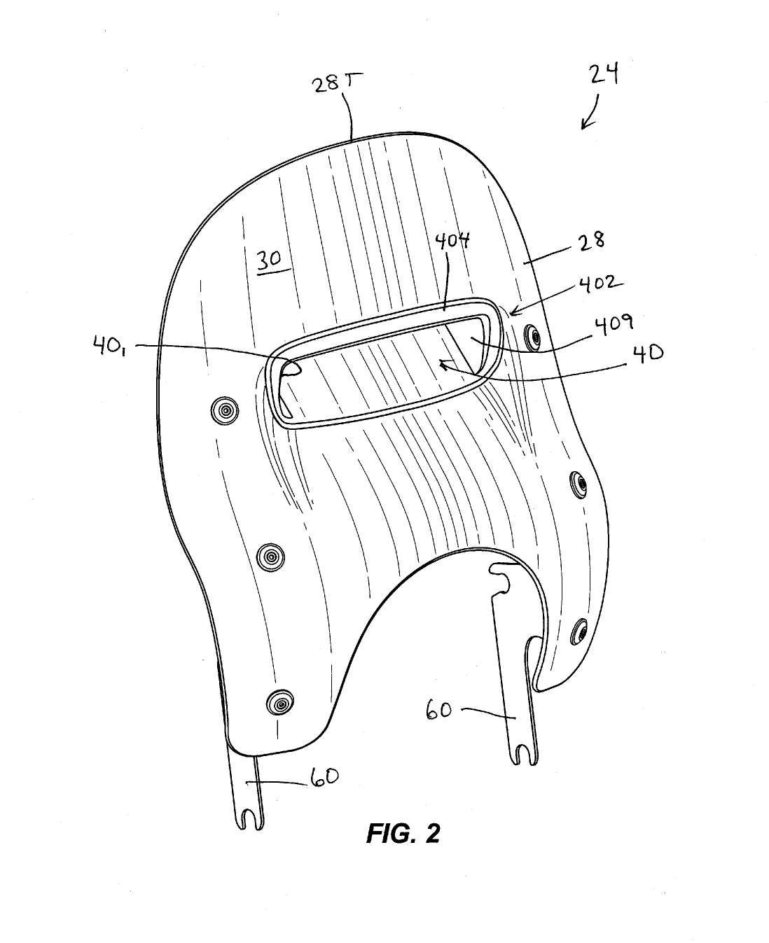

FIG. 1 illustrates a motorcycle 20 including a rear wheel RW drivable by an engine E or other power source to propel the motorcycle 20, a front wheel FW operable to steer the motorcycle 20, a seat S including a surface to support a rider in a cockpit area C in position to operate the motorcycle 20, and a windshield assembly 24. The cockpit area C is defined as the area rearward of the windshield assembly 24 and above the seat S where the rider resides. The windshield assembly 24 includes a windshield 28 having a forward surface 30 and an opposed rearward surface 32. The windshield 28 is provided as a single sheet or panel in which the forward and rearward surfaces 30, 32 are directly opposite each other. The windshield 28 has a top edge 28T. The illustrated windshield 28 is known as a low-profile windshield, which is configured when coupled to the motorcycle 20, to allow the rider to view the road over the windshield 28 (as opposed to a windshield having a height requiring the rider to view the road through the windshield). The top edge 28T of the windshield 28 is positioned at a vertical height H1 not more than about 26 inches (e.g., about 23 to about 25 inches) above the surface of the seat S. In the configuration of the illustrated motorcycle 20, this corresponds to the windshield 28 having a height H2 less than about 22 inches (e.g., about 20 inches). Such low profile windshields may be preferred by many riders to provide a more enjoyable riding experience and/or for a preferred aesthetic appearance, but can subject the rider to undesirable buffeting as turbulent windblast coming over the top edge 28T of the windshield hits the rider, particularly in the head area. The windshield assembly 24 is constructed to reduce buffeting of the rider's head as described in further detail below.

An aperture 36 is provided through the windshield 28 (i.e., extending through the windshield 28 from the forward surface 30 to the rearward surface 32) at a position spaced below the top edge 28T. A duct 40 is positioned to direct air admitted into the aperture 36 through the windshield 28 and into the cockpit area C. The duct 40 has a forward inlet end 40₁ (“inlet”) and a rearward outlet end 40₂ (“outlet”) positioned above the inlet 40₁. The outlet 40₂ is directly exposed to the cockpit area C to direct a steady stream of high velocity air to an upper portion of the cockpit area C during traveling of the motorcycle 20 (e.g., at highway speeds in excess of 40 miles per hour). The velocity of air discharged from the outlet 40₂ is increased from the velocity of traveling wind present at the inlet 40₁. This can be accomplished by providing the duct 40 as a nozzle with the outlet 40₂ being significantly smaller in cross-sectional area than the inlet 40₁. In some constructions, the cross-sectional area of the inlet 40₁ is up to about 15 percent greater (e.g., about 13 percent greater) than the cross-sectional area of the outlet 40₂. However, in other constructions, the cross-sectional area of the inlet 40₁ is no greater than the cross-sectional area of the outlet 40₂ and flow velocity is increased due to the pressure differential present between the forward surface 30 and the area behind the windshield 28 as the motorcycle 20 travels forward. In addition to flow velocity, the total flow rate must be sufficient to provide buffeting protection to the rider. To provide an adequate amount of flow and coverage for the rider's head, the cross-sectional area of the inlet 40₁ can be at least 12.0 square inches, and the outlet 40₂ has a width W₁ that is greater than about one-third of a total width W₂ of the windshield 28, and may be about 50 percent or more of the total width W₂. The duct 40 has a slight curve to follow a contour of the windshield 28 as illustrated.

The duct 40 is oriented at an angle a with respect to the windshield 28 that is at least about 21 degrees and not more than about 35 degrees. For example, the angle a can be at least about 25 degrees and not more than about 31 degrees, and in the illustrated construction, the angle a is about 28 degrees. By directing the high velocity air at this orientation (i.e., toward the upper portion of the cockpit area C where the rider's head is located), the steady flow of air overcomes the buffeting tendency from the traveling wind that flows over the top edge 28T of the windshield 28, and drastically reduces the amount of pressure variation (i.e., buffeting) experienced by the rider's head. It should be noted that the duct 40 is not provided to merely equalize pressure (or reduce pressure differential across the windshield 28), but to actively direct a smooth, consistent traveling wind to the rider's head, which combats or overcomes the tendency for buffeting.

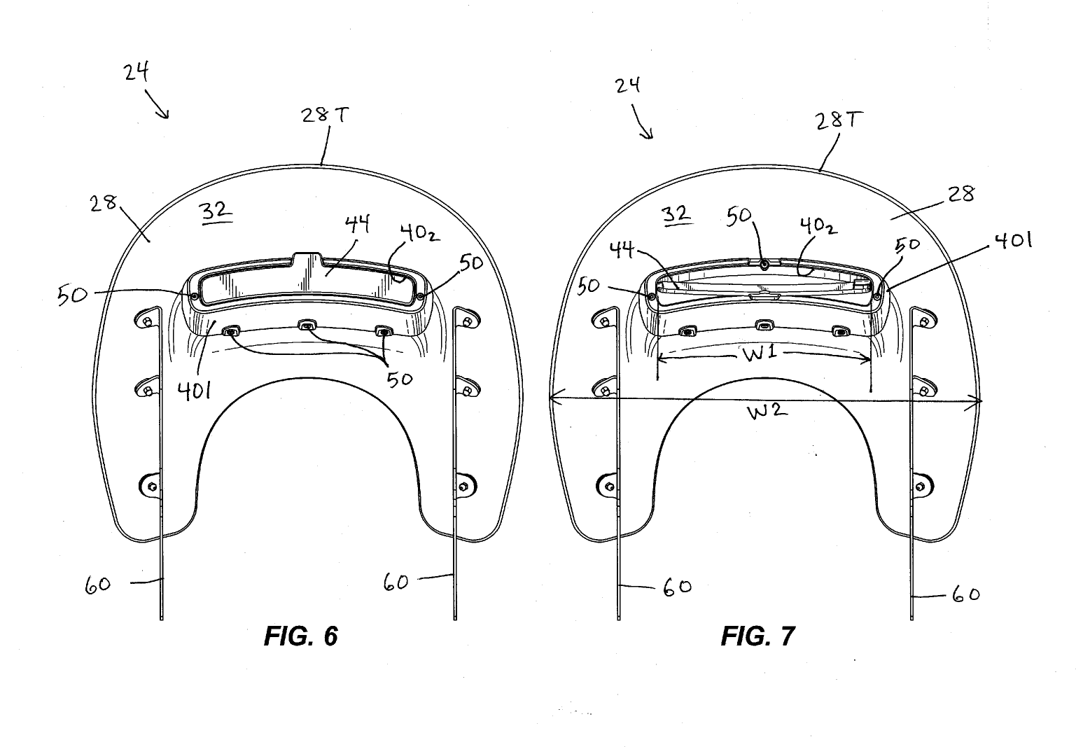

A vane 44 is positioned at least partially within the duct 40. The vane 44 is pivotable about an axis A in the duct 40. The position of the vane 44 is infinitely adjustable between a closed position (FIG. 6) which substantially prevents air flow through the duct 40 and an open position (FIG. 7) which enables maximum air flow through the duct 40. The infinite adjustability can be provided by a friction fitting between the vane 44 and the duct 40. Although infinitely adjustable between the open and closed positions, the vane 44 can securely lock into the open or closed position (e.g., via a detent). In other constructions, the vane 44 may have a plurality of discrete positions between the open and closed positions (e.g., via a plurality of detents). The vane 44 allows the rider to customize the air flow through the duct 40. For example, the rider may prefer that the vane 44 is completely closed when traveling at low speeds for in-town riding, and may prefer the vane 44 is completely open when traveling at high speeds for highway riding. Furthermore, the ability for infinite positioning allows any rider to fine tune the direction of air flow which results in the minimal amount of buffeting for their particular height, riding speed, or riding conditions. When the variable obstruction area of the vane 44 is considered, which reduces the effective cross-sectional area of the outlet 40₂, the cross-sectional area of the inlet 40ᵢ is at least 30 percent greater (e.g., about 35 to 40 percent greater) than the effective cross-sectional area of the outlet 40₂.

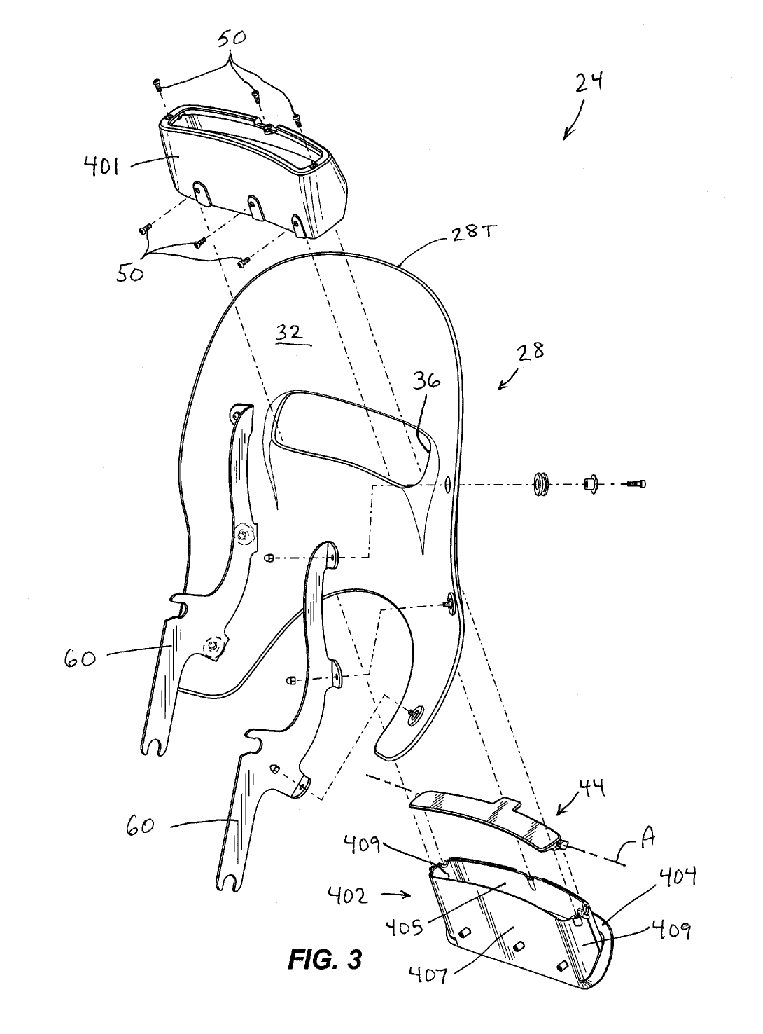

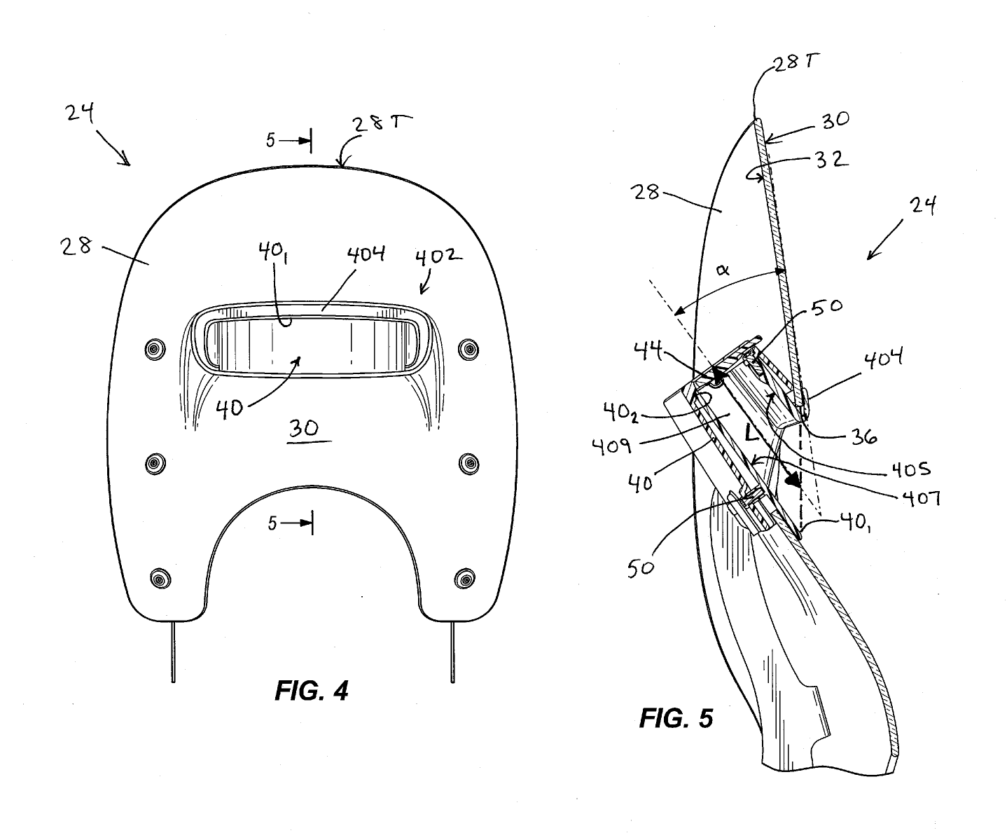

As shown in FIGS. 3 and 5, the duct 40 includes two duct members 401, 402, which nest together and sandwich the windshield 28 adjacent the aperture 36 when coupled together with a plurality of fasteners 50. The first duct member 401 is positioned entirely to the rearward side of the windshield 28. The second duct member 402 extends to the rearward side of the windshield 28, but has a leading portion that engages the forward surface 30 of the windshield 28. In the illustrated construction, the leading portion of the second duct member 402 includes a flange or lip 404 at the upper side such that the second duct member 402 wraps around the aperture 36 and contacts both the forward and rearward surfaces 30, 32 of the windshield 28. The interior of the duct 40 is formed by the second duct member 402, which nests inside the first duct member 401. The interior of the duct 40 includes an upper wall 405 and an opposed lower wall 407. Each of the upper and lower walls 405, 407 is curved to substantially match a curvature of the windshield 28, which extends further rearward toward each of the lateral edges. The upper and lower walls 405, 407 taper slightly toward each other in the direction of air flow from inlet 40₁ to outlet 40₂. Opposed side walls 409 of the duct 40 also taper slightly toward each other in the direction of air flow from inlet 40₁ to outlet 40₂. However, as mentioned above, the duct 40 may taper more or less than shown, or not at all, in other constructions. The duct 40 has a length L measured along its axis or centerline that is at least 3.0 inches, and in some constructions, is at least 3.5 inches. The length of the duct 40 helps maintain the direction of air flow along the intended trajectory toward the upper portion of the cockpit area C after the air exits the outlet 40₂.

Left and right quick-release mounting brackets 60 are secured to the side portions of the windshield 28 to allow tool-free mounting of the windshield assembly 24 onto the motorcycle 20 and tool-free removal from the motorcycle 20. In the illustrated construction, multiple vertically-spaced sets of threaded fasteners, grommets, and nuts are used to couple each bracket 60 to the windshield 28. However, alternate means for coupling the brackets 60 may be provided instead, and entirely different means for mounting the windshield assembly 24 to the motorcycle 20 may be provided instead of the illustrated quick-release brackets 60.

Various features and advantages of the invention are set forth in the following claims.

What is claimed is:

1. A motorcycle windshield assembly comprising:
a windshield having a forward surface and an opposed rearward surface;
an aperture provided through the windshield; and
a duct positioned in the aperture, the duct having a forward facing inlet and a rearward facing outlet positioned above the inlet, the duct having a length measured along a centerline from the inlet to the outlet of at least 3.0 inches,
wherein the outlet extends rearward of the rearward windshield surface and is oriented at an angle that is at least about 21 degrees and not more than about 35 degrees with the windshield.

2. The motorcycle windshield assembly of claim 1, further comprising a vane positioned at least partially within the duct.

3. The motorcycle windshield assembly of claim 2, wherein the vane is pivotable about an axis in the duct.

4. The motorcycle windshield assembly of claim 3, wherein the position of the vane is infinitely adjustable between a closed position and an open position.

5. The motorcycle windshield assembly of claim 2, wherein the vane is positioned at the outlet.

6. The motorcycle windshield assembly of claim 1, wherein the inlet has a width that is greater than about one-third of a total width of the windshield.

7. The motorcycle windshield assembly of claim 1, wherein the duct includes an upper wall and a lower wall that is substantially parallel to the upper wall.

8. The motorcycle windshield assembly of claim 1, wherein the windshield has a height less than about 22 inches.

9. The motorcycle windshield assembly of claim 1, wherein the duct is curved to follow a contour of the windshield.

10. The motorcycle windshield assembly of claim 1, wherein the inlet has a first cross-sectional area and the outlet has a second cross sectional area, the first cross-sectional area being at least 10 percent greater than the second cross-sectional area.

11. The motorcycle windshield assembly of claim 1, wherein the inlet has a cross-sectional area that is at least 12.0 square inches.

12. The motorcycle windshield assembly of claim 1, wherein the outlet is oriented at an angle that is at least about 25 degrees and not more than about 31 degrees with the windshield.

13. The motorcycle windshield assembly of claim 1, wherein the outlet is oriented at an angle of about 28 degrees with the windshield.

14. The motorcycle windshield assembly of claim 1, further comprising a pair of quick-release mounting brackets secured to the windshield.

15. The motorcycle windshield assembly of claim 1, wherein the duct is centrally located along a width of the windshield and occupies a majority of the width.

16. A motorcycle comprising:
a rear wheel drivable to propel the motorcycle;
a front wheel operable to steer the motorcycle;
a seat having a surface configured to support a rider in an upright seated position; and
a windshield assembly positioned forward of the seat to jointly define a cockpit area above the seat and rearward of the windshield assembly, the windshield assembly including
a windshield having a forward surface, an opposed rearward surface, and a top edge, the top edge being no more than 26 inches above the seat surface, and
a duct positioned in an aperture through the windshield, the duct having a forward facing inlet and a rearward facing outlet positioned rearward and above the inlet, the outlet being directly exposed to the cockpit area to direct a steady stream of high velocity air to an upper portion of the cockpit area, wherein the duct is centrally located along a width of the windshield and occupies more than one-third of the width.

17. The motorcycle of claim 16, wherein the outlet extends rearward of the rearward windshield surface and is oriented at an angle that is at least about 21 degrees and not more than about 35 degrees with the windshield

18. The motorcycle of claim 16, wherein the outlet is oriented at an angle that is at least about 25 degrees and not more than about 31 degrees with the windshield.

19. The motorcycle of claim 16, wherein the outlet is oriented at an angle of about 28 degrees with the windshield.

20. The motorcycle of claim 16, wherein the inlet has a cross-sectional area of at least 12.0 square inches.

21. The motorcycle of claim 16, wherein the first cross-sectional area is at least 10 percent greater than the second cross-sectional area.

22. The motorcycle of claim 16, wherein the duct has a length measured along a centerline from the inlet to the outlet of at least 3.0 inches.

23. The motorcycle of claim 16, wherein the duct occupies a majority of the width.
